(19) United States
(12) Patent Application Publication
(10) Pub. No.: US 2026/0280627 A1
(43) Pub. Date: Sep. 17, 2026

(54) CODEBLOCK PARTITIONING FOR MULTIPLE-INPUT MULTIPLE-OUTPUT COMMUNICATIONS

(71) Applicant: QUALCOMM Incorporated, San Diego, CA (US)

(72) Inventors: Ahmed Attia ABOTABL, San Diego, CA (US); Wei YANG, San Diego, CA (US); Jing SUN, San Diego, CA (US)

(21) Appl. No.: 19/078,445

(22) Filed: Mar. 13, 2025

(51) Int. Cl. H04B 7/0456; H04L 1/00

(52) U.S. Cl. CPC H04B 7/0478; H04L 1/0003; H04L 1/0009; H04L 1/0057

(57) ABSTRACT

Various aspects of the present disclosure generally relate to wireless communication. In some aspects, a user equipment (UE) may receive, from a network node, a message including a plurality of codeblocks (CBs), associated with a codeword, that are partitioned into a plurality of CB sets, wherein each CB is mapped to a resource, of a set of resources, associated with the respective CB set, and to one or more layers. The UE may decode the plurality of CBs according to a decoding configuration, wherein successive interference cancellation is applied to each decoded CB. Numerous other aspects are described.

### FIELD OF THE DISCLOSURE

Aspects of the present disclosure generally relate to wireless communication and specifically relate to techniques, apparatuses, and methods associated with codeblock partitioning for multiple-input multiple-output communications.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, various devices may communicate using a multiple-input multiple-output (MIMO) technique, which generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers.

### SUMMARY

Some aspects described herein relate to a user equipment (UE). The UE may include a processing system. The processing system may include one or more processors and one or more code-storing memories coupled with the one or more processors. The processing system may be configured to cause the UE to receive, from a network node, a message including a plurality of codeblocks (CBs), associated with a codeword, that are partitioned into a plurality of CB sets, wherein each CB is mapped to a resource, of a set of resources, associated with the respective CB set, and to one or more layers. The processing system may be configured to cause the UE to decode the plurality of CBs according to a decoding configuration, wherein successive interference cancellation is applied to each decoded CB.

Some aspects described herein relate to a network node. The network node may include a processing system. The processing system may include one or more processors and one or more code-storing memories coupled with the one or more processors. The processing system may be configured to cause the network node to partition a plurality of CBs, associated with a codeword, into a plurality of CB sets. The processing system may be configured to cause the network node to map each CB, of each CB set, to a resource, of a set of resources associated with the respective CB set, and to one or more layers. The processing system may be configured to cause the network node to transmit, to a UE, a message including the plurality of CB sets.

Some aspects described herein relate to a method of wireless communication performed by a UE. The method may include receiving, from a network node, a message including a plurality of CBs, associated with a codeword, that are partitioned into a plurality of CB sets, wherein each CB is mapped to a resource, of a set of resources, associated with the respective CB set, and to one or more layers. The method may include decoding the plurality of CBs according to a decoding configuration, wherein successive interference cancellation is applied to each decoded CB.

Some aspects described herein relate to a method of wireless communication performed by a network node. The method may include partitioning a plurality of CBs, associated with a codeword, into a plurality of CB sets. The method may include mapping each CB, of each CB set, to a resource, of a set of resources associated with the respective CB set, and to one or more layers. The method may include transmitting, to a UE, a message including the plurality of CB sets.

Some aspects described herein relate to a non-transitory computer-readable medium that stores a set of instructions for wireless communication by a UE. The set of instructions, when executed by one or more processors of the UE, may cause the UE to receive, from a network node, a message including a plurality of CBs, associated with a codeword, that are partitioned into a plurality of CB sets, wherein each CB is mapped to a resource, of a set of resources, associated with the respective CB set, and to one or more layers. The set of instructions, when executed by one or more processors of the UE, may cause the UE to decode the plurality of CBs according to a decoding configuration, wherein successive interference cancellation is applied to each decoded CB.

Some aspects described herein relate to a non-transitory computer-readable medium that stores a set of instructions for wireless communication by a network node. The set of instructions, when executed by one or more processors of the network node, may cause the network node to partition a plurality of CBs, associated with a codeword, into a plurality of CB sets. The set of instructions, when executed by one or more processors of the network node, may cause the network node to map each CB, of each CB set, to a resource, of a set of resources associated with the respective CB set, and to one or more layers. The set of instructions, when executed by one or more processors of the network node, may cause the network node to transmit, to a UE, a message including the plurality of CB sets.

Some aspects described herein relate to an apparatus for wireless communication. The apparatus may include means for receiving, from a network node, a message including a plurality of CBs, associated with a codeword, that are partitioned into a plurality of CB sets, wherein each CB is mapped to a resource, of a set of resources, associated with the respective CB set, and to one or more layers. The apparatus may include means for decoding the plurality of CBs according to a decoding configuration, wherein successive interference cancellation is applied to each decoded CB.

Some aspects described herein relate to an apparatus for wireless communication. The apparatus may include means for partitioning a plurality of CBs, associated with a codeword, into a plurality of CB sets. The apparatus may include means for mapping each CB, of each CB set, to a resource, of a set of resources associated with the respective CB set, and to one or more layers. The apparatus may include means for transmitting, to a UE, a message including the plurality of CB sets.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of codeword to layer mapping in multiple-input multiple-output (MIMO) communications.

FIGS. 4A-4D are diagrams illustrating an example associated with codeblock partitioning for MIMO communications.

FIG. 5 is a diagram illustrating an example process performed, for example, at a user equipment (UE) or an apparatus of a UE.

FIG. 6 is a diagram illustrating an example process performed, for example, at a network node or an apparatus of a network node.

FIGS. 7-8 are diagrams of example apparatuses for wireless communication.

### DETAILED DESCRIPTION

In a wireless network, various devices may communicate using a multiple-input multiple-output (MIMO) technique, which generally refers to transmitting or receiving multiple signals (such as multiple layers or multiple data streams) simultaneously over the same time and frequency resources. Data transmitted from a transmitter (e.g., a transport block (TB)) may be segmented into a plurality of codeblocks (CBs). Additionally, one or more CBs may be concatenated together into a codeword (CW), which may represent a block of encoded data that is ready for transmission. In some examples, once a CW is generated, the CW may be mapped onto one or more MIMO layers.

In some examples, a multiple-CW MIMO design may include a different CW mapped to each layer across a scheduled set of resources. In such an example, the design may achieve time and frequency diversity (e.g., CBs of each CW may be mapped across time and frequency resources), but may be limited by a relatively low level of spatial diversity due to each CW being mapped to a single layer. Accordingly, the multiple-CW MIMO design may cause interference in circumstances where different CWs are mapped to different layers within a resource set.

Additionally, in a single-CW design, a single CW may be mapped across multiple resources sets and multiple layers, and a single CB of the CW may be mapped to each resource set. In such an example, the design may achieve spatial diversity (e.g., the single CW may be mapped across multiple layers), but may be limited by a lack of time and frequency diversity due to each CB of the CW being limited to a single resource set. Accordingly, the single CW design may result in less interference (e.g., due to a lack of interfering CWs on different layers), but may require nonlinear or iterative receivers to improve MIMO performance.

Furthermore, in a single-CW spatially-coupled MIMO (SC-MIMO) design, CBs of a single CW may be mapped diagonally across multiple layers and across multiple time and frequency resources, thereby achieving both full spatial diversity and full time and frequency resource diversity. For example, each CB of the CW is mapped to the multiple layers in a staggered, diagonal manner, such that different CBs are mapped to different layers on the same time and frequency resources. A receiver may decode the CBs and perform successive interference cancellation (SIC) on each decoded CB, thereby reducing interference that may otherwise result from the decoded CB. However, where a decoder applies SIC to each decoded CB, there is an increased probability in error propagation resulting from an incorrectly decoded CB or from the decoding of an incorrectly encoded CB. For example, a receiver may incorrectly decode a CB and then perform SIC on the incorrectly decoded CB, and as a result, because the incorrectly decoded CB has been cancelled, the interference associated with the original CB remains (e.g., the interference associated with the incorrectly decoded CB was cancelled). In other words, the cancelled interference is unassociated with the original CB; rather, the interference is cancelled for a mistakenly decoded CB, which may be nonexistent.

Various aspects relate generally to partitioning a plurality of CBs (e.g., associated with a single CW), into a plurality of CB sets, and mapping each CB (e.g., of each CB set) to a resource associated with the respective CB set and to one or more layers. Some aspects more specifically relate to a receiver decoding the plurality of CBs according to a decoding configuration and applying SIC to each decoded CB. For example, each CB set may be decoded independently of the additional CB sets associated with the CW. In some aspects, each CB set may include only two CBs or may include more than two CBs. In some aspects, each CB set is mapped to the set of resources associated with the CB set according to an interlaced mapping configuration or according to a diagonal Bell Laboratories layered space-time (DBLAST) mapping configuration. In some aspects, two or more of the CB sets may be decoded in parallel at the receiver. Additionally, in some aspects, each CB, of each CB set, may be associated with a modulation and coding scheme (MCS) value that is different from an MCS value associated with the remaining CBs in the CB set, or a single MCS value may be associated with all CBs. In some aspects, the receiver may indicate, to a transmitter, a quantity of CB sets that the receiver is capable of decoding in parallel.

Particular aspects of the subject matter described in this disclosure can be implemented to realize one or more of the following potential advantages. In some examples, the described techniques can be used to achieve full spatial diversity and full time and frequency resource diversity, while reducing the probability of error propagation in decoding CBs associated with a CW. Additionally, the described techniques can be used to achieve full spatial diversity and full time and frequency resource diversity, while reducing the potential interference relative to a design in which multiple CWs are mapped across multiple layers. Additionally, in some examples the described techniques may enable the receiver to utilize a linear minimum mean square error (LMMSE) demodulator procedure for each layer for decoding, while maintaining MIMO channel capacity (e.g., where the quantity of MIMO layers is relatively large, such as in an 8×8 MIMO design). In some examples, by indicating the quantity of CB sets that the receiver is capable of decoding in parallel, the receiver may inform the transmitter as to the decoding timeline and the expected time period for receiving a hybrid automatic repeat request (HARQ) acknowledgment (ACK) indication. 5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

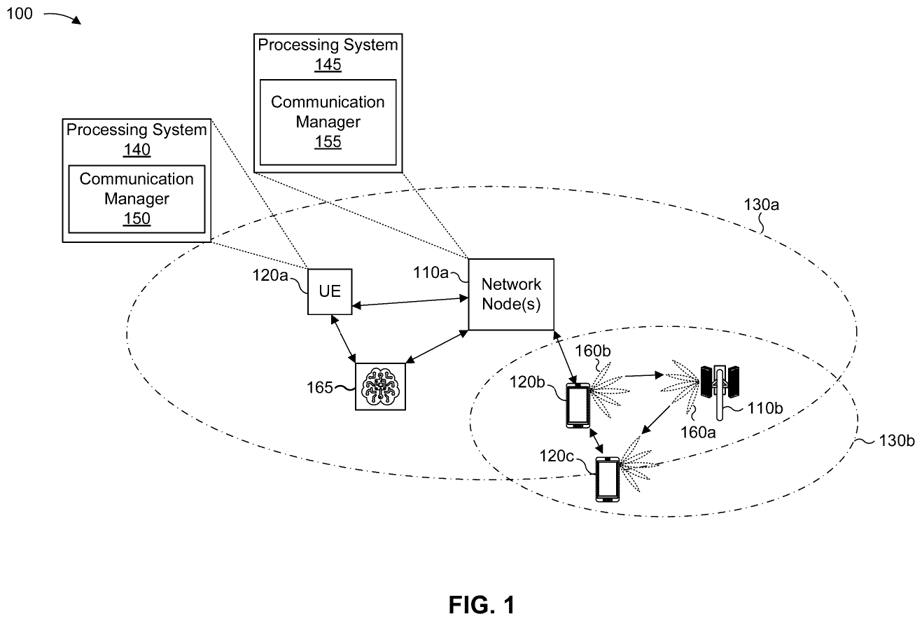

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a MCS or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more TBs of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, from a network node 110, a message including a plurality of CBs, associated with a CW, that are partitioned into a plurality of CB sets, wherein each CB is mapped to a resource, of a set of resources, associated with the respective CB set, and to one or more layers; and decode the plurality of CBs according to a decoding configuration, wherein SIC is applied to each decoded CB. Additionally, or alternatively, the communication manager 150 may perform one or more other operations described herein.

In some aspects, the network node 110 may include a communication manager 155. As described in more detail elsewhere herein, the communication manager 155 may partition a plurality of CBs, associated with a CW, into a plurality of CB sets; map each CB, of each CB set, to a resource, of a set of resources associated with the respective CB set, and to one or more layers; and transmit, to a UE 120, a message including the plurality of CB sets. Additionally, or alternatively, the communication manager 155 may perform one or more other operations described herein.

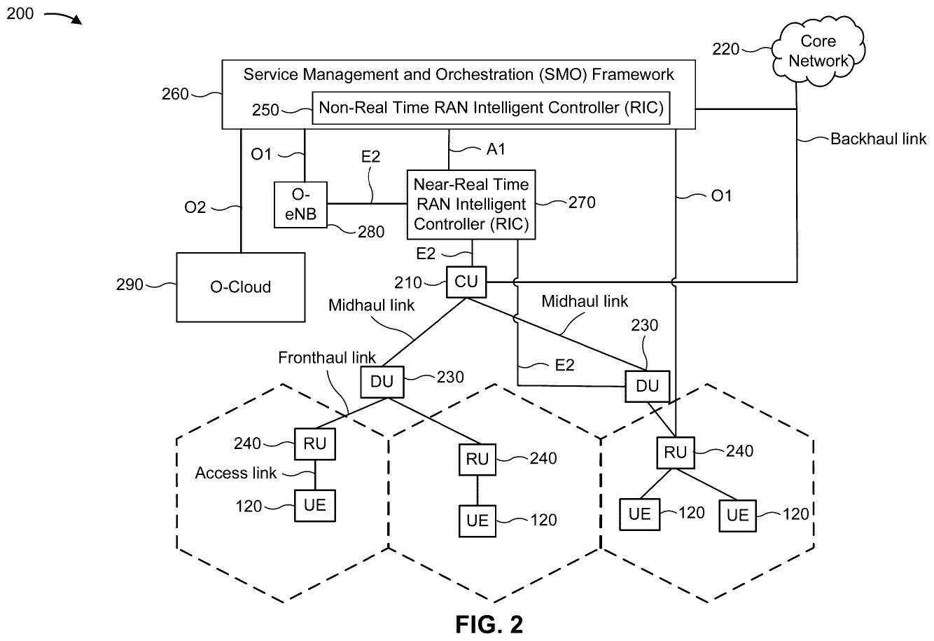

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

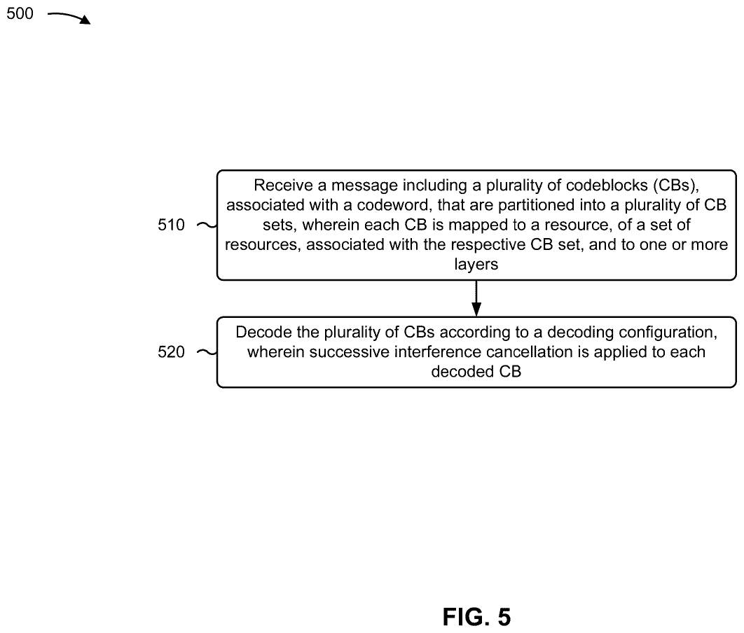

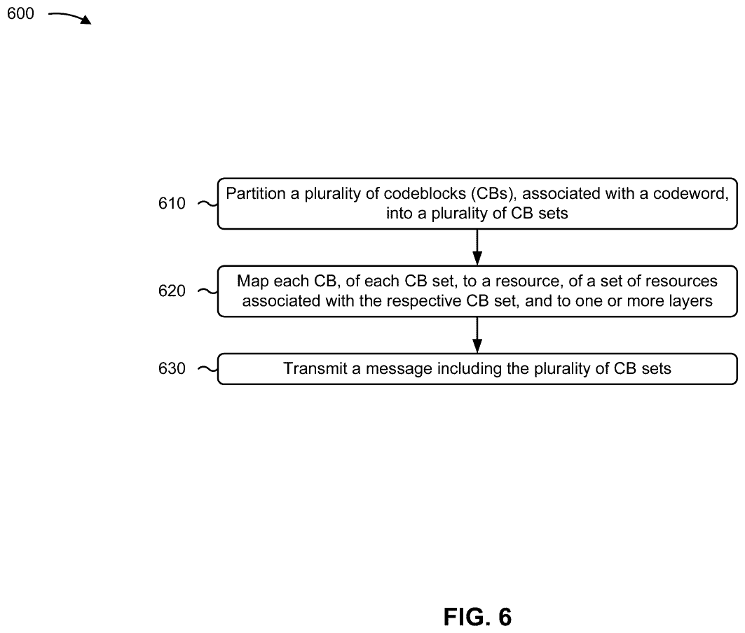

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with CB partitioning for MIMO communications, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

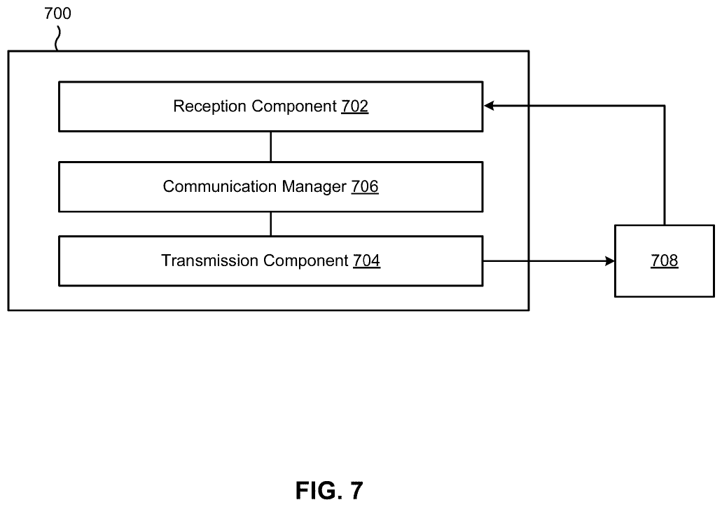

In some aspects, the UE 120 includes means for receiving, from a network node 110, a message including a plurality of CBs, associated with a CW, that are partitioned into a plurality of CB sets, wherein each CB is mapped to a resource, of a set of resources, associated with the respective CB set, and to one or more layers; or means for decoding the plurality of CBs according to a decoding configuration, wherein successive interference cancellation is applied to each decoded CB. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7, among other examples).

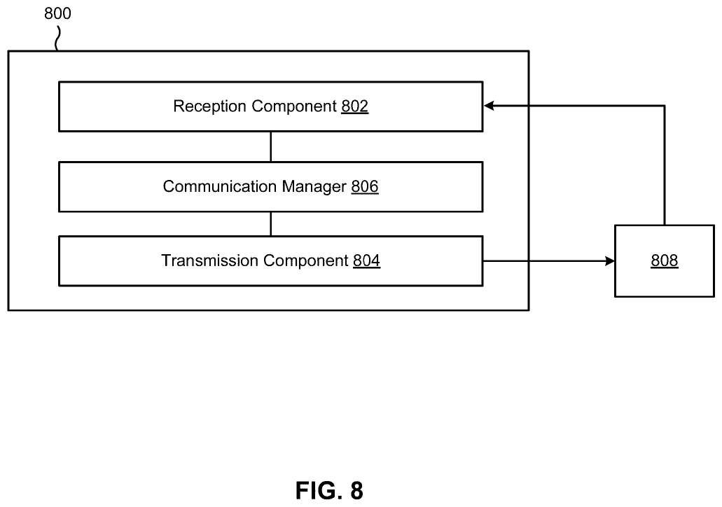

In some aspects, the network node 110 includes means for partitioning a plurality of CBs, associated with a CW, into a plurality of CB sets; means for mapping each CB, of each CB set, to a resource, of a set of resources associated with the respective CB set, and to one or more layers; or means for transmitting, to a UE 120, a message including the plurality of CB sets. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

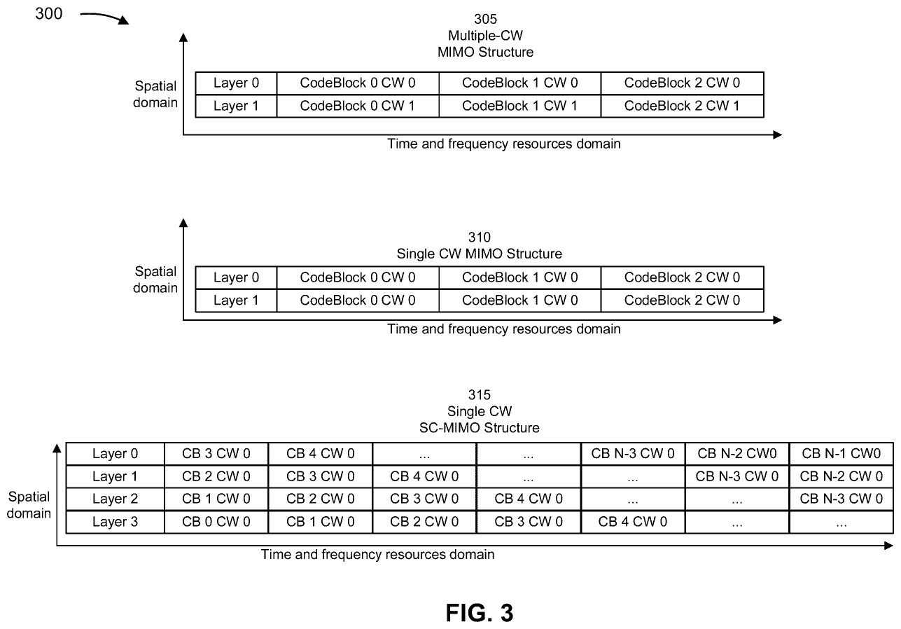

FIG. 3 is a diagram illustrating an example 300 of CW to layer mapping in MIMO communications.

As shown by reference number 305, a multi-CW MIMO design may include CBs associated respectively with a CW 0 and a CW 1 being mapped to different layers and across time and frequency resources. In some examples, a different MCS may be assigned to each CW, and a hard-SIC procedure (e.g. based on binary decoding decisions, as opposed to soft decisions that may rely on probabilities or confidence levels) may be applied during the decoding of the received message. In such an example, an MCS may be selected for each CW, based on channel quality and capacity associated with the layer. Accordingly, the multi-CW design may achieve an improved MIMO capacity utilizing LMMSE and a SIC receiver, due to each CW being mapped to a different layer and potentially utilizing a different MCS for each CW. Although such an example achieves full diversity of time and frequency resources, the multi-CW MIMO design may cause increased interference due to different CWs being mapped to different layers. Furthermore, because different CWs may be mapped to different layers, the multi-CW MIMO design may utilize per-CW CQI and may utilize ACK/NACK feedback for each CW and layer, thereby resulting in increased network and resource overhead.

As shown by reference number 310, a single-CW MIMO design may include a single CW mapped across multiple resources sets, and a single CB of the CW may be mapped to each resource set. In such an example, the design may achieve spatial diversity (e.g., the single CW may be mapped across multiple layers), but may be limited by a lack of time and frequency diversity due to each CB of the CW being limited to a single resource set. In such an example, a non-linear MIMO demodulation procedure (e.g., maximum-likelihood decoding, sphere decoding, or the like) or an iterative demodulation or decoding procedure may be performed across all layers (e.g., due to a single CW being mapped across layers). Additionally, a different LDPC profile may be utilized for different channels of the same capacity. As a result, the single-CW MIMO design may avoid utilizing a layer-specific rate control, and may avoid utilizing separate ACK/NACK feedback per layer. Furthermore, the single CW design may result in less interference (e.g., due to a lack of interfering CWs on different layers). However, in such an example, the single-CW design may require nonlinear or iterative receivers to improve MIMO performance.

As shown by reference number 315, in a single-CW SC-MIMO design, CBs of a single CW may be mapped diagonally across multiple layers and across multiple time and frequency resources, thereby achieving both full spatial diversity and full time and frequency resource diversity. At a transmitter, a single CW may span multiple layers, and an MCS value may be selected according to the average channel quality across multiple layers. For example, each CB of the CW may be mapped to the multiple layers in a staggered, diagonal manner, such that different CBs (e.g., of the same CW) are mapped to different layers on the same time and frequency resources. In some examples, because a single CW is utilized, performance may not be degraded due to a decrease in the accuracy of per-layer CQI, thereby improving performance against CSI mismatch or CSI aging, among other examples.

A receiver may decode the CBs and apply SIC to each decoded CB, thereby reducing interference that may otherwise result from the decoded CB. For example, when decoding CB X, the receiver may assume the decoding results of CB 0 through CB X-1 are known, and accordingly, the receiver may cancel CB 0 through CB X-1 from the received signal (e.g., associated with CB X). For example, the receiver may first decode CB 0 using LMMSE on layer 3. The receiver may then cancel CB 0 (e.g., via SIC), demodulate CB 1 in the first block of resources and CB 1 in the second block of resources (e.g., using LMMSE), and decode CB 1. After decoding CB 1, the receiver may cancel CB 1. As a result, the interference due to CB 0 and CB 1 has been removed, and the receiver may continue to decode CB 2, CB 3, CB 4, and so on.

However, where the receiver applies SIC to each decoded CB, there is an increased probability for error propagation resulting from an incorrectly decoded CB or from the decoding of an incorrectly encoded CB. For example, a receiver may incorrectly decode a CB and then perform SIC on the incorrectly decoded CB, and as a result, because the incorrectly decoded CB has been cancelled, the interference associated with the original CB remains (e.g., the interference associated with the incorrectly decoded CB was cancelled). In other words, the cancelled interference is unassociated with the original CB; rather, the interference is cancelled for a mistakenly decoded CB, which may be nonexistent. As a result, where the MCS value for a single-CW SC-MIMO design is improperly selected, there is an increased probability of error propagation.

Additionally, the decoding order of SC-MIMO may proceed serially by decoding all previous CBs before the receiver may decode the final CB in a message (e.g., the final undecoded CB). As a result, the decoding of CBs appearing later (e.g., in the time and frequency domain mapping) may not be initiated in parallel due to the SIC procedure involving cancellation that proceeds serially through all CBs. In other words, SIC cannot be performed until a CB is decoded, and moving forward in the time and frequency domain resources is therefore limited by the chain of previously-decoded CBs.

As indicated above, FIG. 3 is provided as an example. Other examples may differ from what is described with respect to FIG. 3.

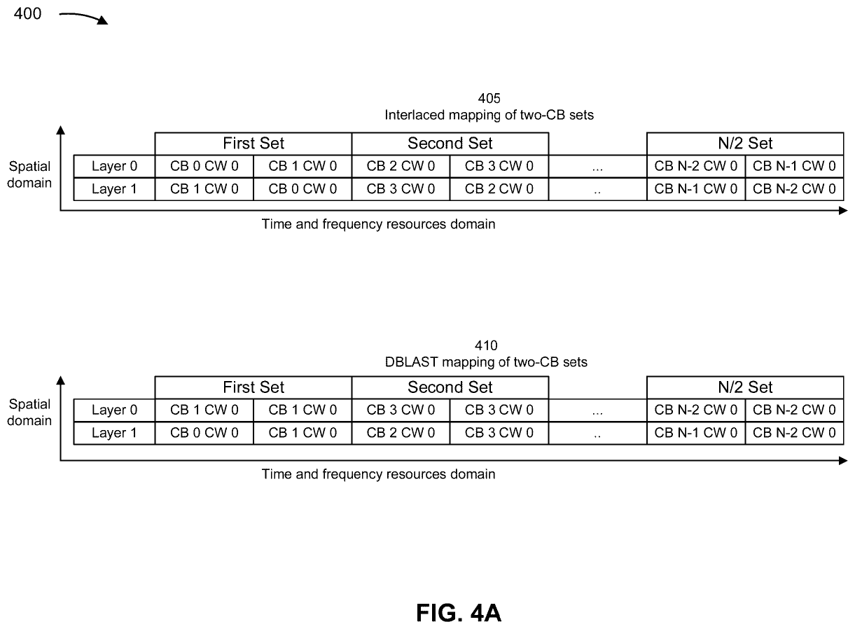

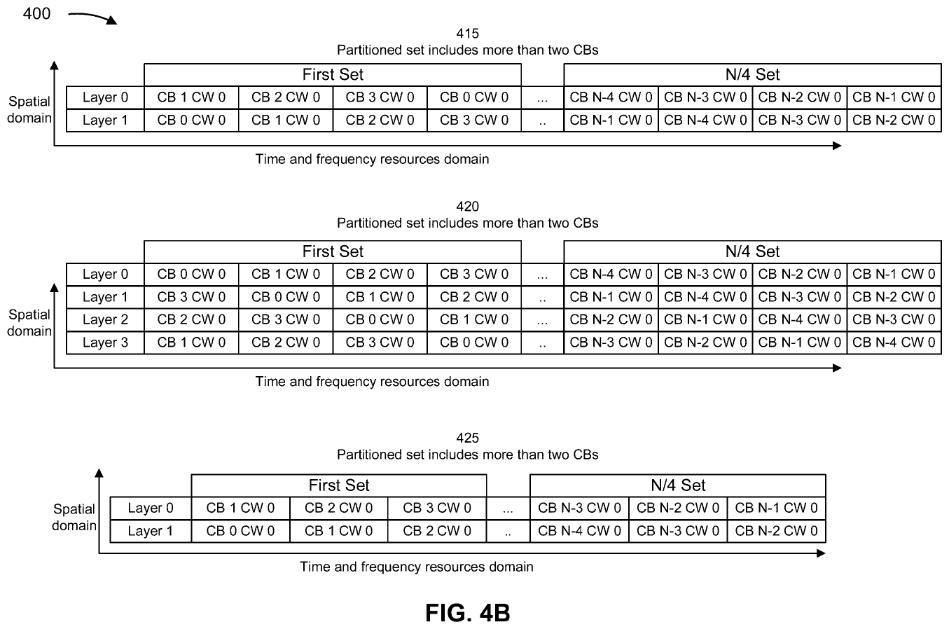

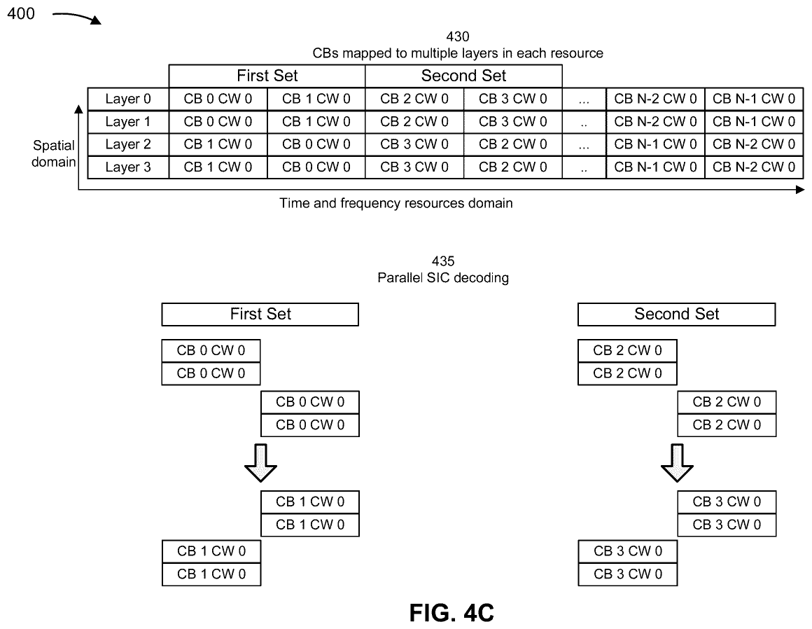

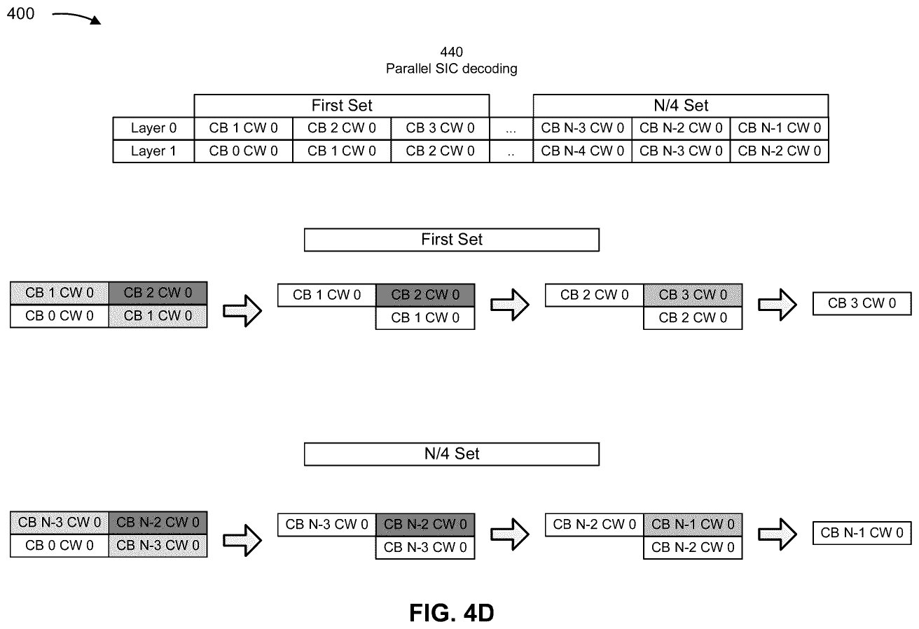

FIGS. 4A-4D are diagrams illustrating an example 400 associated with CB partitioning for MIMO communications. Example 400 may include communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 4A, a plurality of CBs (e.g., associated with a CW) may be partitioned into a plurality of CB sets. Each CB, of each CB set, may be mapped to a resource associated with the respective CB set and to one or more layers. In some aspects, the plurality of CB sets may be transmitted, from a transmitter (e.g., the network node 110), to a receiver (e.g., the UE 120) for demodulation, decoding, and SIC. Additionally, in some aspects, the receiver may decode two or more CB sets in parallel. Additionally, or alternatively, the receiver may decode each CB set independently.

In some aspects, each CB set may include only two CBs, and the CBs from different CB sets may be mapped to orthogonal time and frequency resources. As shown by reference number 405, the CBs within each CB set (e.g., the first set, the second set, the N/2 set, and so on) may be mapped according to an interlaced mapping configuration. In some aspects, each CB may be mapped to a single layer and to a single resource within a CB set. For example, in the first CB set, CB 0 may be mapped to a first resource in layer 0 and a second resource in layer 1, and CB 1 may be mapped to a first resource in layer 1 and a second resource in layer 0. In some aspects, the receiver may first decode CB 1 in layer 1 and then apply SIC to CB 1, thereby removing interference associated with CB 1. The receiver may then decode CB 0, while the interference effects of CB 1 have been removed. The receiver may then apply this decoding procedure to the second set, the third set, the N/2 set, and so on.

As shown by reference number 410, the CBs within each CB set (e.g., the first set, the second set, the N/2 set, and so on) may be mapped according to a DBLAST mapping configuration, which may achieve full spatial diversity and time and frequency resource diversity. For example, in the first CB set, CB 0 may be mapped to a first resource in layer 1, and CB 1 may be mapped to a first resource in layer 0 and to a second resource in layer 0 and layer 1. In some aspects, the receiver may first decode CB 1 in layer 0 and then apply SIC to CB 1, thereby removing interference associated with CB 1. The receiver may then decode CB 1, while the interference effects of CB 0 have been removed. The receiver may then apply this decoding procedure to the second set, the third set, the N/2 set, and so on.

In some aspects, two or more of the first set, the second set, or the N/2 set (e.g., or any additional CB sets) may be demodulated and decoded in parallel according to the techniques described herein. For example, the first set and the second set may be decoded in parallel, and the receiver may apply SIC to the decoded CBs, enabling the receiver to continue decoding CB sets in parallel after decoding the first set and the second set and removing interference associated with the CBs of the first set and the second set.

In some aspects, two MCS values may be applied to each CB set, and a single MCS value may be applied to each CB in each CB set. For example, in a CB set that is mapped according to an interlaced mapping configuration, each CB of the CB set may be configured with a different MCS value.

As shown in FIG. 4B, in some aspects, each CB set may include more than two CBs, and the mapping configuration associated with each CB set may extend across the CBs in each CB set. For example, and as shown by reference number 415, a CB set (e.g., the first set) may include more than two CBs. In some aspects, each CB may be mapped to all layers within the CB set, with an offset in the frequency and time resources. For example, the CBs in each CB set may be mapped according to an interlaced mapping configuration. In other words, the CBs may be mapped such that each CB, of a CB set, is mapped once to each layer and in a different resource. For example, CB 0 may be mapped to layer 1 in a first resource (e.g., a time and frequency resource) and to layer 0 in a last resource, associated with the first set. Similarly, CB 0 may be mapped to layer 0 in the first resource and to layer 1 in a second resource.

In some aspects, the receiver may decode the first set from the first resource to the last resource, and the receiver may cancel (e.g., via SIC) each CB once it is decoded, thereby removing the interference associated with each decoded CB. For example, the receiver may first decode CB 0 in layer 1 (e.g., in the first resource) and then apply SIC to CB 0 in layer 0 (e.g., in the last resource), thereby removing interference associated with CB 0. The receiver may then decode CB 1, while the interference effects of CB 0 have been removed. The receiver may then apply this decoding procedure to the second set, the N/4 set, and so on.

Similarly, and as shown by reference number 420, a CB set may include more than two CBs mapped across more than two layers. In some aspects, each CB may be mapped to all layers within the CB set, with an offset in the frequency and time resources. For example, CB 0 may be mapped to layer 0 in a first resource, to layer 1 in a second resource, to layer 2 in a third resource, and to layer 3 in a fourth resource, associated with the first set. Similarly, CB 3 may be mapped to layer 1 in the first resource, to layer 2 in the second resource, to layer 3 in the third resource, and to layer 0 in the fourth resource. CB 2 may be mapped to layer 2 in the first resource, to layer 3 in the second resource, to layer 0 in the third resource, and to layer 1 in the fourth resource. CB 1 may be mapped to layer 3 in the first resource, to layer 0 in the second resource, to layer 1 in the third resource, and to layer 2 in the fourth resource.

In some aspects, the receiver may decode the first set from the first resource to the fourth (e.g., last) resource, and the receiver may cancel (e.g., via SIC) each CB once it is decoded. For example, the receiver may first decode CB 1 in layer 3 (e.g., in the first resource) and then apply SIC to CB 1, thereby removing interference associated with CB 1. The receiver may then decode CB 2, while the interference effects of CB 1 have been removed. The receiver may then apply SIC to CB 2 in order to remove the interference associated with CB 2. The receiver may then apply this decoding and cancellation procedure to CB 0 and CB 3 within the first set, and may continue applying this decoding procedure to the second set, the N/4 set, and so on.

As shown by reference number 425, in some aspects, one or more of the CBs may have a different size (e.g., include a different quantity of bits, data, or the like) than the remaining CBs in a CB set. In some aspects, CBs may be mapped to one or more layers and one or more resources according to a size associated with each CB. For example, CB 0 may contain a smaller quantity of bits than CB 1, CB 2, or CB 3. As a result, CB 0 may be mapped only to a single layer (e.g., layer 1) and a single resource (e.g., a first resource). In contrast, CB 1 may be mapped to layer 0 (e.g., in the first resource) and to layer 1 (e.g., in the second resource) based on CB 1 containing a larger quantity of bits than CB 0.

As shown in FIG. 4C, and by reference number 430, in some aspects, a CB may be mapped in more than one layer in a resource. For example, CB 0 may be mapped to layer 0 and to layer 1 in a first resource, and may be mapped to layer 2 and to layer 3 in a second resource, associated with a first set. Similarly, CB 1 may be mapped to layer 2 and to layer 3 in the first resource and to layer 0 and to layer 1 in the second resource, associated with the first set. Additionally, in the second set, CB 2 may be mapped to layer 0 and to layer 1 in a third resource (e.g., a first resource in the second set), and to layer 2 and to layer 3 in a fourth resource (e.g., a second resource in the second set). Similarly, CB 3 may be mapped to layer 2 and to layer 3 in the third resource (e.g., the first resource in the second set) and to layer 0 and to layer 1 in the fourth resource (e.g., the second resource in the second set). In some aspects, one or more CBs may be mapped in more than one layer in a resource based on a determination that the number of layers is greater than the number of CBs within a CB set. For example, CB 0 and CB 1 may be mapped across two layers in each resource based on a determination that the number of layers (e.g., four layers) exceeds the number of CBs (e.g., two CBs) in the first set.

Additionally, or alternatively, in some aspects, a single MCS value may be applied to all CBs in a CB set, to all CBs across a plurality of CB sets, or to all CBs across all CB sets. For example, a transmitter (e.g., the network node 110) may select an MCS value for all CBs across all CB sets based on one or more measurements associated with one or more of the CBs (e.g., signal-to-noise ratio (SNR), signal-to-interference-plus-noise ratio (SINR), error vector magnitude (EVM), or channel conditions, among other examples). For example, the transmitter may select an MCS based on the CB having the lowest SINR, which may improve reliability in transmitting the associated message, but may cause a reduction in transmission data rates. Similarly, for example, the transmitter may select an MCS based on an average of SINR measured across all CBs, which may balance the transmission reliability and the transmission data rates. In some aspects, the transmitter may select a single MCS value applied to each CB, two MCS values applied across the CBs, or a quantity of MCS values that matches the quantity of different CBs, based on a determination that a CB set includes more than two CBs and utilizes an interlaced mapping configuration.

For example, where the receiver is configured to decode CB 0 of the first set, followed by decoding CB 1 of the first set, the CB 0 may be assigned a low MCS value due to the potential for high interference. In contrast, CB 1 of the first set may be assigned a relatively higher MCS value due to the potential for relatively lower interference (e.g., due to the CB 0 being cancelled after decoding of CB 0).

As shown by reference number 435, in some aspects, the receiver may decode two or more CB sets (e.g., with each CB set including two different CBs mapped across four layers and two resources) in parallel, while performing SIC to each decoded CB. In some aspects, the first set and the second set may be decoded in parallel, thereby decreasing the overall decoding time for a received message and reducing the probability of error propagation, due to each set being independently decoded. For example, in the first set, CB 0 may be decoded first, and upon decoding, CB 0 may be cancelled (e.g., via SIC), thereby reducing interference caused by CB 0. CB 1 may then be decoded and cancelled. Similarly, the second set may be decoded in parallel with the decoding of the first set. For example, CB 2 may be decoded first, and upon decoding, CB 2 may be cancelled (e.g., via SIC), thereby reducing interference caused by CB 2. CB 3 may then be decoded and cancelled.

Additionally, the receiver may transmit, and the transmitter may receive, an indication indicating a quantity of CB sets for which the receiver is capable of simultaneous decoding. By indicating the quantity of CB sets that the receiver is capable of decoding in parallel, the receiver may inform the transmitter as to the decoding timeline and the expected time period for receiving a HARQ ACK indication.

As shown by reference number 440, in some aspects, the receiver may decode two or more CBs sets (e.g., with each set including four different CBs mapped across two layers and three resources) in parallel, while applying SIC to each decoded CB. In some aspects, the first set and the N/4 set (e.g., and one or more intervening CB sets) may be decoded in parallel, thereby decreasing the overall decoding time for a received message and reducing the probability of error propagation, due to each set being independently decoded. For example, prior to decoding, CB 0 may experience interference from CB 1, CB 2, or CB 3 in the first set. Accordingly, CB 0 may be decoded first, and upon decoding CB 0, CB 0 may be cancelled (e.g., via SIC), thereby removing the interference associated with CB 0. CB 1 may then be decoded, and upon decoding CB 1, CB 1 may be cancelled, thereby removing the interference associated with CB 1. CB 2 may then be decoded, and upon decoding CB 2, CB 2 may be cancelled, thereby removing the interference associated with CB 2. CB 3 may then be decoded, at which point, there may be no remaining interference from any CBs in the first set. Similarly, each additional set (e.g., through the N/4 set) may be decoded as described here, where each CB is cancelled following decoding

In some aspects, decoding efficiency may be improved based on two or more CWs being aligned in respective boundaries, thereby enabling streamlined decoding of the CBs in a first CW and a second CW. Similarly, decoding latency may be reduced based a smaller CB size relative to a multi-CW MIMO approach.

As described herein, some examples include partitioning a plurality of CBs (e.g., associated with a single CW), into a plurality of CB sets, and mapping each CB (e.g., of each CB set) to a resource associated with the respective CB set and to one or more layers. Some aspects more specifically relate to a receiver decoding the plurality of CBs according to a decoding configuration and applying SIC to each decoded CB. For example, each CB set may be decoded independently of the additional CB sets associated with the CW. In some aspects, each CB set may include only two CBs or may include more than two CBs. In some aspects, each CB set is mapped to the set of resources associated with the CB set according to an interlaced mapping configuration or according to a DBLAST mapping configuration. In some aspects, two or more of the CB sets may be decoded in parallel at the receiver. Additionally, in some aspects, each CB, of each CB set, may be associated with an MCS value that is different from an MCS value associated with the remaining CBs in the CB set, or a single MCS value may be associated with all CBs. In some aspects, the receiver may indicate, to a transmitter, a quantity of CB sets that the receiver is capable of decoding in parallel.

As a result, the described techniques can be used to achieve full spatial diversity and full time and frequency resource diversity, while reducing the probability of error propagation in decoding CBs associated with a CW. Additionally, the described techniques can be used to achieve full spatial diversity and full time and frequency resource diversity, while reducing the potential interference relative to a design in which multiple CWs are mapped across multiple layers. Additionally, in some examples the described techniques may enable the receiver to utilize an LMMSE demodulator procedure for each layer for decoding, while maintaining MIMO channel capacity (e.g., where the quantity of MIMO layers is relatively large, such as in an 8×8 MIMO design). In some examples, by indicating the quantity of CB sets that the receiver is capable of decoding in parallel, the receiver may inform the transmitter as to the decoding timeline and the expected time period for receiving a HARQ ACK indication. Similarly, by implementing independent decoding for each CB set, the receiver may prevent error propagation that may occur in scenarios where a receiver decodes all CBs in a message in a serial fashion (e.g., proceeding from a first resource to a last resource of the message).

As indicated above, FIGS. 4A-4D are provided as an example. Other examples may differ from what is described with respect to FIGS. 4A-4D.

FIG. 5 is a diagram illustrating an example process 500 performed, for example, at a UE or an apparatus of a UE. Example process 500 is an example where the apparatus or the UE (e.g., UE 120) performs operations associated with CB partitioning for MIMO communications.

As shown in FIG. 5, in some aspects, process 500 may include receiving, from a network node, a message including a plurality of CBs, associated with a CW, that are partitioned into a plurality of CB sets, wherein each CB is mapped to a resource, of a set of resources, associated with the respective CB set, and to one or more layers (block 510). For example, the UE (e.g., using reception component 702 or communication manager 706, depicted in FIG. 7) may receive, from a network node, a message including a plurality of CBs, associated with a CW, that are partitioned into a plurality of CB sets, wherein each CB is mapped to a resource, of a set of resources, associated with the respective CB set, and to one or more layers, as described above.

As further shown in FIG. 5, in some aspects, process 500 may include decoding the plurality of CBs according to a decoding configuration, wherein successive interference cancellation is applied to each decoded CB (block 520). For example, the UE (e.g., using communication manager 706, depicted in FIG. 7) may decode the plurality of CBs according to a decoding configuration, wherein successive interference cancellation is applied to each decoded CB, as described above.

Process 500 may include additional aspects, such as any single aspect or any combination of aspects described below or in connection with one or more other processes described elsewhere herein.

In a first aspect, each CB set includes only two CBs.

In a second aspect, alone or in combination with the first aspect, each CB, of each CB set, is mapped to the set of resources associated with the respective CB set, according to an interlaced mapping configuration.

In a third aspect, alone or in combination with one or more of the first and second aspects, each CB, of each CB set, is associated with a MCS value that is different from an MCS value associated with the remaining CB in the respective CB set.

In a fourth aspect, alone or in combination with one or more of the first through third aspects, each CB, of each CB set, is mapped to the set of resources associated with the respective CB set, according to a DBLAST mapping configuration.

In a fifth aspect, alone or in combination with one or more of the first through fourth aspects, each set of CBs includes more than two CBs.

In a sixth aspect, alone or in combination with one or more of the first through fifth aspects, each CB, of each CB set, is mapped to the set of resources associated with the respective CB set, according to an interlaced mapping configuration.

In a seventh aspect, alone or in combination with one or more of the first through sixth aspects, each CB, of each CB set, is mapped to a different layer, of the one or more layers, in each of one or more resources, of the set of resources associated with the respective CB set.

In an eighth aspect, alone or in combination with one or more of the first through seventh aspects, each CB, of each CB set, is mapped to the set of resources associated with the respective CB set, according to a DBLAST mapping configuration.

In a ninth aspect, alone or in combination with one or more of the first through eighth aspects, one or more CBs, of each CB set, are associated with a different quantity of bits than one or more remaining CBs, of the CB set.

In a tenth aspect, alone or in combination with one or more of the first through ninth aspects, one or more CBs, of each CB set, are mapped to a plurality of the one or more layers in a resource, of the set of resources associated with the respective CB set.

In an eleventh aspect, alone or in combination with one or more of the first through tenth aspects, the one or more CBs are mapped to the plurality of the one or more layers based on a determination that a quantity of layers associated with the message exceeds a quantity of CBs in the respective CB set.

In a twelfth aspect, alone or in combination with one or more of the first through eleventh aspects, two or more CB sets, of the plurality of CB sets, are decoded in parallel.

In a thirteenth aspect, alone or in combination with one or more of the first through twelfth aspects, process 500 includes transmitting, to the network node, a capability indication that indicates a quantity of CB sets that the UE is capable of decoding in parallel.

In a fourteenth aspect, alone or in combination with one or more of the first through thirteenth aspects, a single modulation and coding scheme is associated with all CBs, of the plurality of CBs.

In a fifteenth aspect, alone or in combination with one or more of the first through fourteenth aspects, a different modulation and coding scheme value is associated with each CB in each CB set based on a determination that the CBs, of the CB set, are mapped to the set of resources associated with the CB set, according to an interlaced mapping configuration.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with CB partitioning for MIMO communications.

As shown in FIG. 6, in some aspects, process 600 may include partitioning a plurality of CBs, associated with a CW, into a plurality of CB sets (block 610). For example, the network node (e.g., using communication manager 806, depicted in FIG. 8) may partition a plurality of CBs, associated with a CW, into a plurality of CB sets, as described above.

As further shown in FIG. 6, in some aspects, process 600 may include mapping each CB, of each CB set, to a resource, of a set of resources associated with the respective CB set, and to one or more layers (block 620). For example, the network node (e.g., using communication manager 806, depicted in FIG. 8) may map each CB, of each CB set, to a resource, of a set of resources associated with the respective CB set, and to one or more layers, as described above.

As further shown in FIG. 6, in some aspects, process 600 may include transmitting, to a UE, a message including the plurality of CB sets (block 630). For example, the network node (e.g., using transmission component 804 or communication manager 806, depicted in FIG. 8) may transmit, to a UE, a message including the plurality of CB sets, as described above.

Process 600 may include additional aspects, such as any single aspect or any combination of aspects described below or in connection with one or more other processes described elsewhere herein.

In a first aspect, each CB set includes only two CBs.

In a second aspect, alone or in combination with the first aspect, each CB, of each CB set, is mapped to the set of resources associated with the respective CB set, according to an interlaced mapping configuration.

In a third aspect, alone or in combination with one or more of the first and second aspects, each CB, of each CB set, is associated with a MCS value that is different from an MCS value associated with the remaining CB in the respective CB set.

In a fourth aspect, alone or in combination with one or more of the first through third aspects, each CB, of each CB set, is mapped to the set of resources associated with the respective CB set, according to a DBLAST mapping configuration.

In a fifth aspect, alone or in combination with one or more of the first through fourth aspects, each set of CBs includes more than two CBs.

In a sixth aspect, alone or in combination with one or more of the first through fifth aspects, each CB, of each CB set, is mapped to the set of resources associated with the respective CB set, according to an interlaced mapping configuration.

In a seventh aspect, alone or in combination with one or more of the first through sixth aspects, each CB, of each CB set, is mapped to a different layer, of the one or more layers, in each of one or more resources of the set of resources associated with the respective CB set.

In an eighth aspect, alone or in combination with one or more of the first through seventh aspects, each CB, of each CB set, is mapped to the set of resources associated with the respective CB set, according to a DBLAST mapping configuration.

In a ninth aspect, alone or in combination with one or more of the first through eighth aspects, one or more CBs, of each CB set, are associated with a different quantity of bits than one or more remaining CBs, of the CB set.

In a tenth aspect, alone or in combination with one or more of the first through ninth aspects, one or more CBs, of each CB set, are mapped to a plurality of the one or more layers in a resource, of the set of resources associated with the respective CB set.

In an eleventh aspect, alone or in combination with one or more of the first through tenth aspects, the one or more CBs are mapped to the plurality of the one or layers based on a determination that a quantity of layers associated with the message exceeds a quantity of CBs in the respective CB set.

In a twelfth aspect, alone or in combination with one or more of the first through eleventh aspects, process 600 includes receiving, from the UE, a capability indication that indicates a quantity of CB sets that the UE is capable of decoding in parallel.

In a thirteenth aspect, alone or in combination with one or more of the first through twelfth aspects, a single modulation and coding scheme is associated with all CBs, of the plurality of CBs.

In a fourteenth aspect, alone or in combination with one or more of the first through thirteenth aspects, a different modulation and coding scheme value is associated with each CB in each CB set based on a determination that the CBs, of the CB set, are mapped to the set of resources associated with the CB set, according to an interlaced mapping configuration.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 4A, 4B, 4C, or 4D.. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive, from a network node, a message including a plurality of CBs, associated with a CW, that are partitioned into a plurality of CB sets, wherein each CB is mapped to a resource, of a set of resources, associated with the respective CB set, and to one or more layers. The communication manager 706 may decode the plurality of CBs according to a decoding configuration, wherein successive interference cancellation is applied to each decoded CB.

The transmission component 704 may transmit, to the network node, a capability indication that indicates a quantity of CB sets that the UE is capable of decoding in parallel.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 4A, 4B, 4C, or 4D. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The communication manager 806 may partition a plurality of CBs, associated with a CW, into a plurality of CB sets. The communication manager 806 may map each CB, of each CB set, to a resource, of a set of resources associated with the respective CB set, and to one or more layers. The transmission component 804 may transmit, to a UE, a message including the plurality of CB sets.

The reception component 802 may receive, from the UE, a capability indication that indicates a quantity of CB sets that the UE is capable of decoding in parallel.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving, from a network node, a message including a plurality of codeblocks (CBs), associated with a codeword, that are partitioned into a plurality of CB sets, wherein each CB is mapped to a resource, of a set of resources, associated with the respective CB set, and to one or more layers; and decoding the plurality of CBs according to a decoding configuration, wherein successive interference cancellation is applied to each decoded CB.

Aspect 2: The method of Aspect 1, wherein each CB set includes only two CBs.

Aspect 3: The method of Aspect 2, wherein each CB, of each CB set, is mapped to the set of resources associated with the respective CB set, according to an interlaced mapping configuration.

Aspect 4: The method of Aspect 3, wherein each CB, of each CB set, is associated with a modulation and coding scheme (MCS) value that is different from an MCS value associated with the remaining CB in the respective CB set.

Aspect 5: The method of Aspect 2, wherein each CB, of each CB set, is mapped to the set of resources associated with the respective CB set, according to a diagonal Bell Laboratories layered space-time (DBLAST) mapping configuration.

Aspect 6: The method of any of Aspects 1-5, wherein each set of CBs includes more than two CBs.

Aspect 7: The method of Aspect 6, wherein each CB, of each CB set, is mapped to the set of resources associated with the respective CB set, according to an interlaced mapping configuration.

Aspect 8: The method of Aspect 7, wherein each CB, of each CB set, is mapped to a different layer, of the one or more layers, in each of one or more resources, of the set of resources associated with the respective CB set.

Aspect 9: The method of Aspect 6, wherein each CB, of each CB set, is mapped to the set of resources associated with the respective CB set, according to a diagonal Bell Laboratories layered space-time (DBLAST) mapping configuration.

Aspect 10: The method of Aspect 9, wherein one or more CBs, of each CB set, are associated with a different quantity of bits than one or more remaining CBs, of the CB set.

Aspect 11: The method of any of Aspects 1-10, wherein one or more CBs, of each CB set, are mapped to a plurality of the one or more layers in a resource, of the set of resources associated with the respective CB set.

Aspect 12: The method of Aspect 11, wherein the one or more CBs are mapped to the plurality of the one or more layers based on a determination that a quantity of layers associated with the message exceeds a quantity of CBs in the respective CB set.

Aspect 13: The method of any of Aspects 1-12, wherein two or more CB sets, of the plurality of CB sets, are decoded in parallel.

Aspect 14: The method of any of Aspects 1-13, further comprising: transmitting, to the network node, a capability indication that indicates a quantity of CB sets that the UE is capable of decoding in parallel.

Aspect 15: The method of any of Aspects 1-14, wherein a single modulation and coding scheme is associated with all CBs, of the plurality of CBs.

Aspect 16: The method of any of Aspects 1-15, wherein a different modulation and coding scheme value is associated with each CB in each CB set based on a determination that the CBs, of the CB set, are mapped to the set of resources associated with the CB set, according to an interlaced mapping configuration.

Aspect 17: A method of wireless communication performed by a network node, comprising: partitioning a plurality of codeblocks (CBs), associated with a codeword, into a plurality of CB sets; mapping each CB, of each CB set, to a resource, of a set of resources associated with the respective CB set, and to one or more layers; and transmitting, to a UE, a message including the plurality of CB sets.

Aspect 18: The method of Aspect 17, wherein each CB set includes only two CBs.

Aspect 19: The method of Aspect 18, wherein each CB, of each CB set, is mapped to the set of resources associated with the respective CB set, according to an interlaced mapping configuration.

Aspect 20: The method of Aspect 19, wherein each CB, of each CB set, is associated with a modulation and coding scheme (MCS) value that is different from an MCS value associated with the remaining CB in the respective CB set.

Aspect 21: The method of Aspect 18, wherein each CB, of each CB set, is mapped to the set of resources associated with the respective CB set, according to a diagonal Bell Laboratories layered space-time (DBLAST) mapping configuration.

Aspect 22: The method of any of Aspects 17-21, wherein each set of CBs includes more than two CBs.

Aspect 23: The method of Aspect 22, wherein each CB, of each CB set, is mapped to the set of resources associated with the respective CB set, according to an interlaced mapping configuration.

Aspect 24: The method of Aspect 23, wherein each CB, of each CB set, is mapped to a different layer, of the one or more layers, in each of one or more resources of the set of resources associated with the respective CB set.

Aspect 25: The method of Aspect 22, wherein each CB, of each CB set, is mapped to the set of resources associated with the respective CB set, according to a diagonal Bell Laboratories layered space-time (DBLAST) mapping configuration.

Aspect 26: The method of Aspect 25, wherein one or more CBs, of each CB set, are associated with a different quantity of bits than one or more remaining CBs, of the CB set.

Aspect 27: The method of any of Aspects 17-26, wherein one or more CBs, of each CB set, are mapped to a plurality of the one or more layers in a resource, of the set of resources associated with the respective CB set.

Aspect 28: The method of Aspect 27, wherein the one or more CBs are mapped to the plurality of the one or layers based on a determination that a quantity of layers associated with the message exceeds a quantity of CBs in the respective CB set.

Aspect 29: The method of any of Aspects 17-28, further comprising: receiving, from the UE, a capability indication that indicates a quantity of CB sets that the UE is capable of decoding in parallel.

Aspect 30: The method of any of Aspects 17-29, wherein a single modulation and coding scheme is associated with all CBs, of the plurality of CBs.

Aspect 31: The method of any of Aspects 17-30, wherein a different modulation and coding scheme value is associated with each CB in each CB set based on a determination that the CBs, of the CB set, are mapped to the set of resources associated with the CB set, according to an interlaced mapping configuration.

Aspect 32: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-31.

Aspect 33: An apparatus for wireless communication at a device, the apparatus comprising one or more memories and one or more processors coupled to the one or more memories, the one or more processors configured to cause the device to perform the method of one or more of Aspects 1-31.

Aspect 34: An apparatus for wireless communication, the apparatus comprising at least one means for performing the method of one or more of Aspects 1-31.

Aspect 35: A non-transitory computer-readable medium storing code for wireless communication, the code comprising instructions executable by one or more processors to perform the method of one or more of Aspects 1-31.

Aspect 36: A non-transitory computer-readable medium storing a set of instructions for wireless communication, the set of instructions comprising one or more instructions that, when executed by one or more processors of a device, cause the device to perform the method of one or more of Aspects 1-31.

Aspect 37: A device for wireless communication, the device comprising a processing system that includes one or more processors and one or more memories coupled with the one or more processors, the processing system configured to cause the device to perform the method of one or more of Aspects 1-31.

Aspect 38: An apparatus for wireless communication at a device, the apparatus comprising one or more memories and one or more processors coupled to the one or more memories, the one or more processors individually or collectively configured to cause the device to perform the method of one or more of Aspects 1-31.

Aspect 39: A device comprising a processing system that includes one or more processors and one or more code-storing memories coupled with the one or more processors, the processing system configured to cause the device to perform the method of one or more of Aspects 1-31.

Aspect 40: A device comprising a processing system that includes processor circuitry and code-storing memory circuitry, the processing system configured to cause the device to perform the method of one or more of Aspects 1-31.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a message including a plurality of codeblocks (CBs), associated with a codeword, that are partitioned into a plurality of CB sets, wherein each CB is mapped to a resource, of a set of resources, associated with the respective CB set, and to one or more layers; and
decode the plurality of CBs according to a decoding configuration, wherein successive interference cancellation is applied to each decoded CB.

2. The UE of claim 1, wherein each CB set includes only two CBs.

3. The UE of claim 2, wherein each CB, of each CB set, is mapped to the set of resources associated with the respective CB set, according to an interlaced mapping configuration.

4. The UE of claim 3, wherein each CB, of each CB set, is associated with a modulation and coding scheme (MCS) value that is different from an MCS value associated with the remaining CB in the respective CB set.

5. The UE of claim 2, wherein each CB, of each CB set, is mapped to the set of resources associated with the respective CB set, according to a diagonal Bell Laboratories layered space-time (DBLAST) mapping configuration.

6. The UE of claim 1, wherein each set of CBs includes more than two CBs.

7. The UE of claim 6, wherein each CB, of each CB set, is mapped to the set of resources associated with the respective CB set, according to an interlaced mapping configuration.

8. The UE of claim 7, wherein each CB, of each CB set, is mapped to a different layer, of the one or more layers, in each of one or more resources, of the set of resources associated with the respective CB set.

9. The UE of claim 6, wherein each CB, of each CB set, is mapped to the set of resources associated with the respective CB set, according to a diagonal Bell Laboratories layered space-time (DBLAST) mapping configuration.

10. The UE of claim 9, wherein one or more CBs, of each CB set, are associated with a different quantity of bits than one or more remaining CBs, of the CB set.

11. A network node, comprising:
a processing system that includes one or more processors and one or more code-storing memories coupled with the one or more processors, the processing system configured to cause the network node to:
partition a plurality of codeblocks (CBs), associated with a codeword, into a plurality of CB sets;
map each CB, of each CB set, to a resource, of a set of resources associated with the respective CB set, and to one or more layers; and
transmit, to a UE, a message including the plurality of CB sets.

12. The network node of claim 11, wherein each CB set includes only two CBs.

13. The network node of claim 11, wherein each set of CBs includes more than two CBs.

14. The network node of claim 13, wherein each CB, of each CB set, is mapped to the set of resources associated with the respective CB set, according to an interlaced mapping configuration.

15. The network node of claim 11, wherein one or more CBs, of each CB set, are mapped to a plurality of the one or more layers in a resource, of the set of resources associated with the respective CB set.

16. The network node of claim 15, wherein the one or more CBs are mapped to the plurality of the one or layers based on a determination that a quantity of layers associated with the message exceeds a quantity of CBs in the respective CB set.

17. The network node of claim 11, wherein the processing system is configured to cause the network node to:
receive, from the UE, a capability indication that indicates a quantity of CB sets that the UE is capable of decoding in parallel.

18. The network node of claim 11, wherein a single modulation and coding scheme is associated with all CBs, of the plurality of CBs.

19. The network node of claim 11, wherein a different modulation and coding scheme value is associated with each CB in each CB set based on a determination that the CBs, of the CB set, are mapped to the set of resources associated with the CB set, according to an interlaced mapping configuration.

20. A method of wireless communication performed by a user equipment (UE), comprising:
receiving, from a network node, a message including a plurality of codeblocks (CBs), associated with a codeword, that are partitioned into a plurality of CB sets, wherein each CB is mapped to a resource, of a set of resources, associated with the respective CB set, and to one or more layers; and
decoding the plurality of CBs according to a decoding configuration, wherein successive interference cancellation is applied to each decoded CB.
